(19) United States
(12) Patent Application Publication
(10) Pub. No.: US 2004/0263279 A1
(43) Pub. Date: Dec. 30, 2004

(54) Coupling device for facilitating communications between a physical line and a wireless terminal

(76) Inventor: Ronald W. Jocher, East Hanover, NJ (US)

Correspondence Address: CARLSON, GASKEY & OLDS, P.C., 400 WEST MAPLE ROAD, SUITE 350, BIRMINGHAM, MI, 48009, US

(21) Appl. No.: 10/602,962

(22) Filed: Jun. 24, 2003

(51) Int. Cl. H01P 5/02

(52) U.S. Cl. 333/24 C; 343/700 MS; 343/702

(57) ABSTRACT

A communication device (20) includes a wireless communication terminal (22) and a coupling device (24) that facilitates communications between the wireless terminal (22) and a physical line (26). The coupling device (24) includes a stripline conductor (40) that is placed near the antenna (30) of the wireless terminal to establish a proximity coupling between the strip line conductor and the antenna (30). Communication in either direction between the wireless terminal (22) and the physical line (26) are facilitated by the coupling device (24) of this invention.

### FIELD OF THE INVENTION

This invention generally relates to signal communications using an interface between a physical line and a wireless communication terminal.

### DESCRIPTION OF THE RELATED ART

Wireless communication terminals such as cell phones, lap top or notebook computers, air cards and personal digital assistants, are well known. Such devices typically include an antenna for emitting or receiving radio frequency signals containing voice, video or data, for example.

While such devices have proven useful for their intended purpose, there are situations where the antennas of such devices do not facilitate communicating different signal forms using the devices. For example, there is no known device for readily interfacing a wireless terminal antenna with a physical transmission line. There are situations where such a device would be useful. One example includes a testing facility where wireless terminals are tested and the ability to communicate signals along a physical transmission line to and from such terminals is advantageous.

This invention addresses the need for making wireless terminals readily adaptable for signal communications propagated along a physical line.

### SUMMARY OF THE INVENTION

In general terms, this invention is a device for coupling a wireless terminal antenna to a physical line.

One example device designed according to this invention includes a strip line conductor that is adapted to be placed near an antenna of the wireless terminal to establish a proximity coupling between the conductor and the antenna. In one example, the strip line conductor is supported on one side of a dielectric layer and a ground plane is supported on another side of the dielectric layer. One example device includes a connector that is electrically coupled to the strip line conductor. The connector is adapted to be connected to a physical, conductive line such as a transmission line or a coax cable.

A method of this invention includes proximity coupling a wireless terminal antenna with a strip line conductor that is connected to a physical line along which signals are propagated to or from the wireless terminal. In one example, an H-field coupling is established between the wireless terminal antenna and the strip line conductor to facilitate signal communication between the wireless terminal and the physical line.

The various features and advantages of this invention will become apparent to those skilled in the art from the following detailed description. The drawings that accompany the detailed description can be briefly described as follows.

### BRIEF DESCRIPTION OF THE DRAWINGS

FIG. 1 schematically illustrates a wireless terminal with a coupling device designed according to this invention.

FIG. 2 is a side view of the embodiment of FIG. 1.

FIG. 3 schematically illustrates an example coupling device designed according to this invention.

FIG. 4 is a cross-sectional illustration taken along the lines 4-4 in FIG. 1.

### DETAILED DESCRIPTION

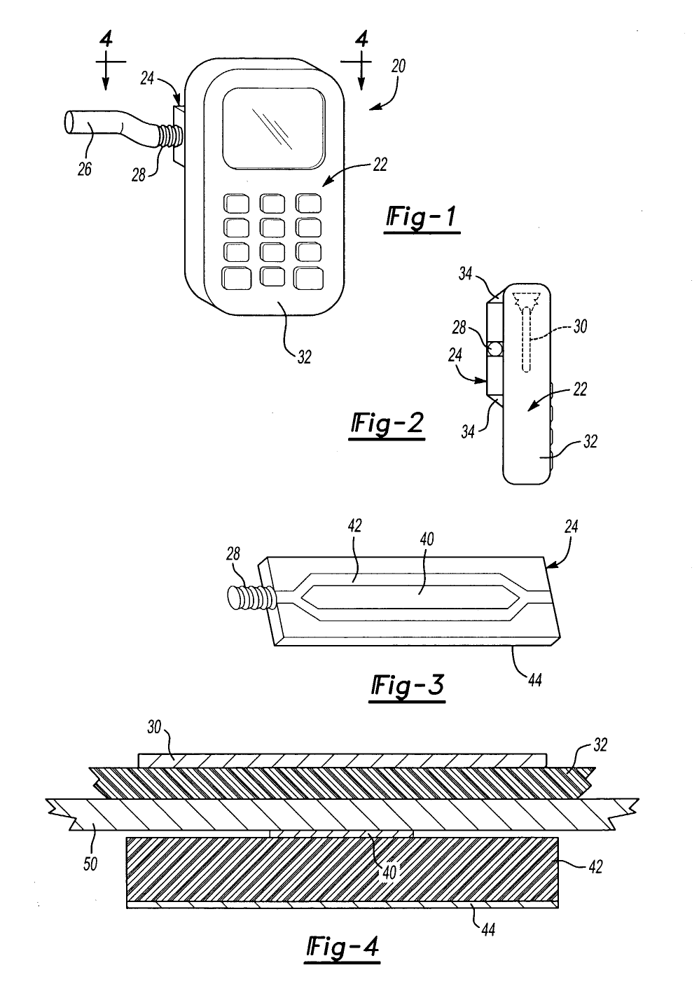

FIG. 1 schematically illustrates a communication device 20 that includes a wireless terminal 22 and a coupling device 24. The wireless terminal 22 in this example is a cell phone. The invention is not limited to any particular type of wireless terminal. Other example terminals include personal digital assistants, notebook computers, PCMCIA air cards and other known terminals with built-in, non-accessible RF ports or antennas.

The coupling device 24 facilitates communications between the wireless terminal 22 and a physical line 26. In one example, the line 26 comprises a transmission line. In another example the line 26 comprises a coax cable. A connector 28 facilitates coupling the physical line 26 to the coupling device 24.

As best appreciated from FIGS. 1 and 2, the coupling device 24 is placed adjacent the wireless terminal 22 near an antenna 30 of the wireless terminal 22. In the illustrated example, the terminal 22 includes an outer housing 32 that is made of a known plastic material. The illustrated example (as best shown in FIG. 2) includes a holder portion 34 that facilitates securing the coupling device 24 in position relative to the housing 32 of the terminal 22. The holder portion 34 may be an adhesive, tape, or snap-fit arrangement, for example. In this position, the coupling device 24 establishes a proximity coupling between the antenna 30 and a strip line conductor portion 40 of the coupling device 24.

As shown in FIG. 3, one example coupling device 24 designed according to this invention includes a strip line conductor 40 supported on a dielectric layer 42. A ground plane 44 is supported on an opposite side of the dielectric layer 42. Known materials can be used for making the conductor 40, dielectric layer 42 and ground plane 44. In one example, the strip line conductor 40 is a microstrip metallic conductor that is made of tinned copper or gold-plated copper. In one example, the dielectric layer 42 is a glass fiber reinforced Teflon. In another example, a ceramic dielectric substrate is used.

The coupling device 24, and more particularly the strip line conductor 40 of the coupling device 24, and the antenna 30 cooperate as if the two were a hybrid microstrip including a proximity feed or proximity coupling between the antenna 30 and strip line conductor 40. The operation of hybrid microstrips is generally known.

In one example, the physical geometry of the strip line conductor 40 and the associated portions of the coupling device 24 are selected to eliminate the electrical field portion of the electromagnetic coupling between the strip line conductor 40 and the antenna 30. Such a device is predominately magnetically coupled (i.e., the H-field is the dominant portion of the electromagnetic coupling). Minimizing or eliminating the E-field portion of the coupling minimizes any radiation to free space from the strip line conductor 40.

Referring to FIG. 4, the effective dielectric constant of the communication device 20 is based upon the dielectric constant of the dielectric substrate 42, the dielectric constant of the housing portion 32 of the wireless terminal 22 and the dielectric of air 50 in any gap between the strip line conductor 40 and the housing 32. In the illustrated example, the dielectric constant of the gap 50 is 1.0 and the dielectric constants of the dielectric substrate 42 and the housing 32 are determined based upon the known characteristics of the materials selected to from those parts.

In one example, once the effective dielectric constant is determined, the choice for the operating frequency and the desired bandwidth are used to determine the length and thickness desired for the strip line conductor 40. Those skilled in the art who have the benefit of this description will be able to develop an appropriate geometry and configuration of the coupling device 24 to achieve a desired level of performance.

This invention has the advantage of being very economical and permitting a hardwire coupling to a wireless communication terminal that does not alter the terminal in any way. Additionally, the inventive coupling device is very broadband and minimizes any loss associated with the proximity coupling. This invention takes advantage of known microstrip antenna techniques and provides a readily useable, reliable and economic coupling between a physical line and a wireless communication terminal.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

I claim:

1. A method of using a wireless terminal antenna for communication through a physical line, comprising:
proximity coupling the wireless terminal antenna with a strip line conductor connected to the physical line.

2. The method of claim 1, including receiving a wirelessly transmitted signal at the terminal antenna and transmitting the signal along the physical line.

3. The method of claim 1, including emitting a signal from the terminal antenna and transmitting the signal along the physical line.

4. The method of claim 1, including transmitting a signal along the physical line and receiving the signal at the terminal antenna.

5. The method of claim 1, including placing the strip line conductor adjacent a casing of the wireless terminal.

6. The method of claim 1, including using an H-field coupling between the wireless terminal antenna and the strip line conductor.

7. A device for coupling a wireless terminal to a physical line, comprising:
a strip line conductor adapted to be placed near an antenna of the wireless terminal to establish a proximity coupling between the conductor and the antenna.

8. The device of claim 7, including a dielectric layer for supporting the conductor on one side and a ground plane on another side of the dielectric layer.

9. The device of claim 7, including a connector electrically coupled to the strip line conductor adapted to be connected to a physical, conductive line.

10. A communication device, comprising:
a wireless terminal having an antenna for receiving and transmitting wireless signals; and
at least one strip line conductor proximity coupled to the antenna.

11. The device of claim 10, including a dielectric layer for supporting the strip line conductor on one side and a ground plane on another side of the dielectric.

12. The device of claim 10, wherein the wireless terminal includes a housing and the strip line conductor is adjacent the housing.

13. The device of claim 12, including a holder for securing the strip line conductor in a desired position against the housing.
